(19) United States
(12) Patent Application Publication
(10) Pub. No.: US 2026/0057879 A1
(43) Pub. Date: Feb. 26, 2026

(54) CREATING LANGUAGE IDENTIFIERS FOR USE IN AUDIENCE MEASUREMENT

(71) Applicant: The Nielsen Company (US), LLC, New York, NY (US)

(72) Inventors: John T. LiVoti, Clearwater, FL (US); Stanley Wellington Woodruff, Palm Harbor, FL (US); David H. Wright, Safety Harbor, FL (US); Cherisse Ponraj, Dunedin, FL (US)

(21) Appl. No.: 19/307,943

(22) Filed: Aug. 22, 2025

Related U.S. Application Data
(60) Provisional application No. 63/686,944, filed on Aug. 26, 2024.

(51) Int. Cl. G10L 15/00

(52) U.S. Cl. CPC G10L 15/005

(57) ABSTRACT

In one example, a method is described. The method includes receiving, at a meter, audio data associated with media content from a media device; determining a language associated with the media content based on a media content voice analysis; assigning a language identifier associated with the language; and creating a meter event for the language identifier by tagging the audio data with metadata corresponding to the language identifier.

### CROSS-REFERENCE TO RELATED APPLICATION(S)

This disclosure claims the benefit of U.S. Provisional Patent Application No. 63/686,944, filed Aug. 26, 2024, which is hereby incorporated herein by reference in its entirety.

### BACKGROUND

The present disclosure relates in general to crediting media content, and in particular, to crediting in view of a language of the media content.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, a method is described. The method includes receiving, at a meter, audio data associated with media content from a media device; determining a language associated with the media content based on a media content voice analysis; assigning a language identifier associated with the language; and creating a meter event for the language identifier by tagging the audio data with metadata corresponding to the language identifier.

In another aspect, a non-transitory computer-readable storage medium, having stored thereon program instructions that, upon execution by a processor, cause performance of operations is described. The operations include receiving, at a meter, audio data associated with media content from a media device; determining, at a meter, a language associated with the media content based on a media content voice analysis; assigning a language identifier associated with the language; creating a meter event for the language identifier; and transmitting, to a server, the audio data with the meter event.

In another aspect, a computing system is described. The computing system includes a processor and a non-transitory computer-readable storage medium, having stored thereon program instructions that, upon execution by the processor, cause performance of operations. The operations include receiving audio data associated with media content from a media device; determining a language associated with the media content based on a media content voice analysis; assigning a language identifier associated with the language; and creating a meter event for the language identifier.

### BRIEF DESCRIPTION OF THE DRAWINGS

FIG. 1 is a diagrammatic illustration of an example media exposure environment in communication with an example central facility disclosed herein in accordance with one or more aspects.

FIG. 2 is a simplified block diagram of an example computing device in accordance with one or more aspects.

FIG. 3 is a simplified block diagram of an example system in accordance with one or more aspects.

FIG. 4 is a simplified block diagram of an example system in accordance with one or more aspects.

FIG. 5 is a simplified block diagram of an example system in accordance with one or more aspects.

FIG. 6 is a flow chart of an example method arranged in accordance with examples described herein.

FIG. 7 is a flow chart of an example method arranged in accordance with examples described herein.

FIG. 8 is a flow chart of an example method arranged in accordance with examples described herein.

FIG. 9A is a flow chart of an example method arranged in accordance with examples described herein.

FIG. 9B is a flow chart of an example method arranged in accordance with examples described herein.

FIG. 10 is a flow chart of an example method for creating language identifiers in accordance with one or more aspects.

### DETAILED DESCRIPTION

### I. Overview

The list of podcasts, television shows, movies, and other media content is ever increasing, and as this list grows, determining what a user is watching becomes more and more difficult. Meters can be used to collect information about what the user is watching. The meter can capture audio codes known as watermarks, audio snippets referred to as signatures, and/or obtain IP traffic (e.g., as a streaming meter). For example, the meter can send a signature to a central facility associated with an audience measurement entity (“AME”). At the AME, the signature is compared to a plurality of reference signatures in a reference database. The reference signatures are associated with known media content. Matching the signature to a reference signature allows the central facility to determine what a user was watching, and therefore, the media can be credited. However, as the list of media content and the number of platforms hosting media content grows, so does the reference database.

Several examples are described herein for advantageously using direct audio signals of media content to identify a language associated with the media content. For example, a user can watch their favorite Korean drama. The meter can collect a first signature for the Korean drama. The meter can determine the language of the first signature as Korean. Once the language of the media content is identified, the first signature can create a meter language event by tagging such as through adding metadata (for example, a Korean language identifier and a timestamp). By tagging the first signature, the first signature is now associated with the Korean language. When the first signature is compared to a plurality of reference signatures, the first signature can be compared to only the reference signatures that are also associated with the Korean language identifier. In some examples, the reference signatures are separated based on identified languages into respective databases, and therefore, the signature can only be compared to reference signatures of the database associated with the same language (i.e., Korean). After watching the Korean drama, the user can watch an NFL® game, and a second signature can be acquired during the football game. The operations would be repeated and the second signature would be associated with an English language identifier, rather than the Korean language identifier.

Various examples are described herein for advantageously using direct audio signals of media content to identify a language associated with the media content by using the central facility. The central facility can create the meter language event. Advantageously, in creating the meter language event at the central facility, the central facility can associate the meter language events with a reference database, which is often located at the central facility itself. In yet other examples, the central facility creates meter language events for the reference signatures of a reference database.

Several examples are described herein for advantageously determining a language of a media content. For example, a user can watch a movie in English that has a scene in French. Therefore, one signature can be tagged with a French language identifier, but the remainder of signatures are tagged with English language identifiers. Systems and methods described herein describe determining which language is the primary, also referred to herein as, most-viewed language and which language is the secondary, also referred to herein as, second-most viewed language. The primary and secondary languages can be used to determine the media content.

The operations and systems, described herein, provide techniques for improving audience measurement technology by reducing the time and resources (e.g., computing power, computing time, and cost) to credit media—by only searching and/or comparing the audio signal to reference audio signals with the same language as the identified language of the audio signal.

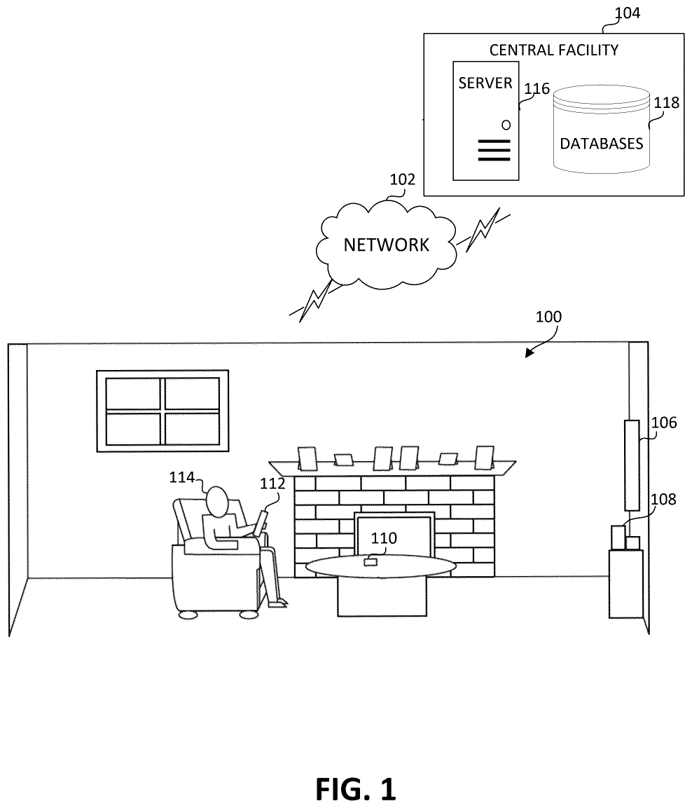

FIG. 1 is an illustration of an example media exposure environment 100 in communication via network 102 with an example central facility 104. The media exposure environment 100 includes a media device 106 and a loudspeaker 108 in direct communication with the media device 106. The media exposure environment 100 can have at least one of: a meter 110 for collecting audience measurement data in the media exposure environment 100, and a portable meter 112 for collecting audience measurement data for a user 114. The example central facility 104 includes a server 116 and databases 118. The server 116 is in communication with the databases 118 for crediting media exposure. The central facility 104 is remote from the media exposure environment 100 and is associated with the AME.

In the illustrated example of FIG. 1, the media exposure environment 100 is a room of a household (e.g., a room in a home of a panelist of an AME) that has been statistically selected to develop media ratings data for population(s)/demographic(s) of interest. In the illustrated example, the media device 106 is a television, and the meter 110 is located at a position away from the media device 106. In the illustrated example, one or more persons (such as the user 114) of the household have registered with the AME (e.g., by agreeing to be a panelist) and have provided demographic information to the AME to enable associating demographics with viewing activities (e.g., media exposure) for crediting media.

In one or more aspects, the media exposure environment 100 is a different room in the household than that illustrated by FIG. 1 such as a kitchen or a bedroom. In some aspects, the media exposure environment 100 is a vehicle such as a car or airplane. In some aspects, the media exposure environment 100 can be in a room of a non-statistically selected home, a theater, a tavern, a retail location, an arena, or the like.

In some aspects, the network 102 can be a wired or wireless network. For example, the network 102 can be Bluetooth® network, the Internet, a cellular telephone network, an Ethernet network, any type of service provider network, any other type of wide area network, and/or any type of local area network.

In one or more aspects, the central facility 104 is in communication with the media exposure environment 100 via the network 102. In particular, the meter 110 and/or the portable meter 112 can communicate audio signals and media exposure information such as timestamps, language identifiers (as described herein), and the like via the network to central facility 104.

In several aspects, the media device 106 is a device other than a television such as another information presentation device. An information presentation can include a radio, a video game console, a tablet, a laptop, a cellular telephone, a smartphone, a computer, the loudspeakers 108, and the like. In some aspects, the media device 106 includes a television and the loudspeakers 108 operably associated with the television.

In one or more aspects, the loudspeakers 108, such as external surround-sound speakers, are moved within the media exposure environment 100. In other aspects, the loudspeakers 108 are built into the media device 106. In yet other aspects, the loudspeakers 108 are headphones or earbuds worn by the user 114. Generally, the loudspeakers 108 can be any speaker suitable in the media exposure environment 100 and which outputs the sound from the media device 106.

In at least one aspect, the meter 110 is an audience measurement device provided to the user 114 and/or a household associated with the user 114 for collecting and/or analyzing the data from the media device 106. The meter 110, in some aspects, is coupled directly to the media device 106. In other aspects, a universal serial bus (USB) dongle is coupled to the media device 106, and the USB dongle wirelessly couples the media device 106 to the meter 110. In some aspects, the meter 110 is moveable around the media exposure environment 100 and/or can be positioned in a number of locations around the media exposure environment 100 to detect audio signals from the media device 106 and/or the loudspeakers 108.

In one or more aspects, the portable meter 112 is an audience measurement device provided to the user 114 for collecting and/or analyzing media viewed by the user 114 such as the media device 106. The portable meter 112 can be a wearable device such as a watch, necklace, headphones, or a device that can be clipped onto clothes of the user 114 that collects and analyzes media viewed by the user. The portable meter 112 can be an application or a website on a media device such as the media device 106 for collecting and/or analyzing media viewed by the user 114. The portable meter 112 can be used when the media exposure environment is a non-statistically selected environment such as a bar or gym. The portable meter 112 can be used when the media device 106 (such as a cell phone or laptop) being measured is the media device with the application or website for collecting and/or analyzing media viewed by the user 114.

In one or more aspects, the user 114 is a panelist. In other aspects, the user 114 is not associated with the panel and is a guest to the media exposure environment 100. In yet other aspects, additional persons are located within the media exposure environment 100.

In some aspects, the server 116 can be a single server or a plurality of servers. The server 116 can be a central processor system that is in communication with the databases 118. The server 116 can have a rules-based engine to determine which database of the databases 118 to access.

In various aspects, the databases 118 can store a plurality of reference signatures. Each database of the databases 118 contains a plurality of reference signatures for a particular language. For example, a first database of the databases 118 can contain reference signatures associated with media content in English, a second database of the databases 118 can contain reference signatures associated with media content in French, a third database of the databases 118 can contain reference signatures that contain a primary language of English and a secondary language of Japanese, and the like.

In operation, the media device 106 is turned on and begins to present media content. The loudspeakers 108 operably coupled to the media device 106 transmit audio signals corresponding to the media content. The meter 110 and/or the portable meter 112 of the user 114 begin to receive the audio signals looking for watermarks within the media content and collecting signatures of the audio signals. The meter 110 and/or the portable meter 112 can identify the language associated with the media content of the signature, as described herein, and include a language identifier in the metadata of the signature. The signature (including the added metadata) is sent to the central facility 104, via the network 102. The signature is received at the server 116 of the central facility to be analyzed for media crediting. The server 116 can compare, using the language identifier the language of the signature, the signature to one or more reference signatures in a database of the databases associated with the same language and/or language identifier. Once a match is found between the signature and a reference signature, the server 116 will credit the media as having been viewed.

In some embodiments, as described herein, the server 116 determines the language identifier of the signature, rather than the meter 110 or the portable meter 112.

### II. System Architecture

Any one or more of the components described herein can take the form of a computing device, or a computing system that includes one or more computing devices.

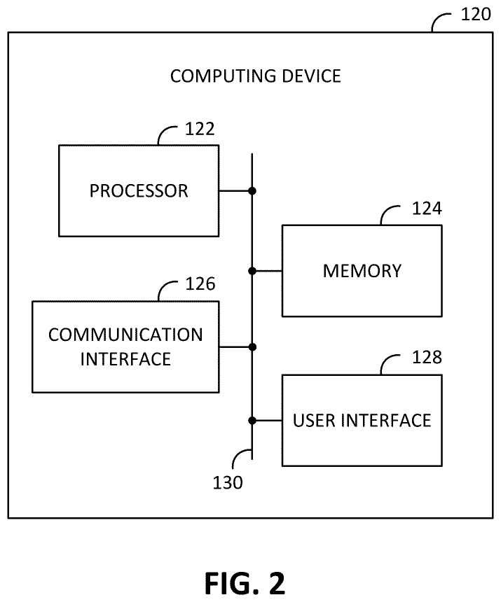

FIG. 2 is a simplified block diagram of an example computing device 120. The computing device 120 can be configured to perform one or more operations, such as the operations described in this disclosure. As shown, the computing device 120 can include various components, such as a processor 122, memory 124, a communication interface 126, and/or a user interface 128. These components can be connected to each other (or to another device, system, or other entity) via a connection mechanism 130.

The processor 122 can include one or more general-purpose processors and/or one or more special-purpose processors.

Memory 124 can include one or more volatile, non-volatile, removable, and/or non-removable storage components, such as magnetic, optical, or flash storage, and/or can be integrated in whole or in part with the processor 122. Further, memory 124 can take the form of a non-transitory computer-readable storage medium, having stored thereon computer-readable program instructions (e.g., compiled or non-compiled program logic and/or machine code) that, upon execution by the processor 122, cause the computing device 120 to perform one or more operations, such as those described in this disclosure. The program instructions can define and/or be part of a discrete software application. In some examples, the computing device 120 can execute the program instructions in response to receiving an input (e.g., via the communication interface 126 and/or the user interface 128). Memory 124 can also store other types of data, such as those types described in this disclosure. In some examples, memory 124 can be implemented using a single physical device, while in other examples, memory 124 can be implemented using two or more physical devices.

The communication interface 126 can include one or more wired interfaces (e.g., an Ethernet interface) or one or more wireless interfaces (e.g., a cellular interface, Wi-Fi interface, or Bluetooth® interface). Such interfaces allow the computing device 120 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission. In some instances, the network 102 is the communication interface 126.

The user interface 128 can facilitate interaction between computing device 120 and a user of computing device 120, if applicable. As such, the user interface 128 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 128 can include hardware and/or software components that facilitate interaction between the computing device 120 and the user of the computing device 120.

The connection mechanism 130 can be a cable, system bus, computer network connection, or other form of a wired or wireless connection between components of the computing device 120.

One or more of the components of the computing device 120 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 120 can be combined into a single component, and the function described herein for a single component can be subdivided among multiple components.

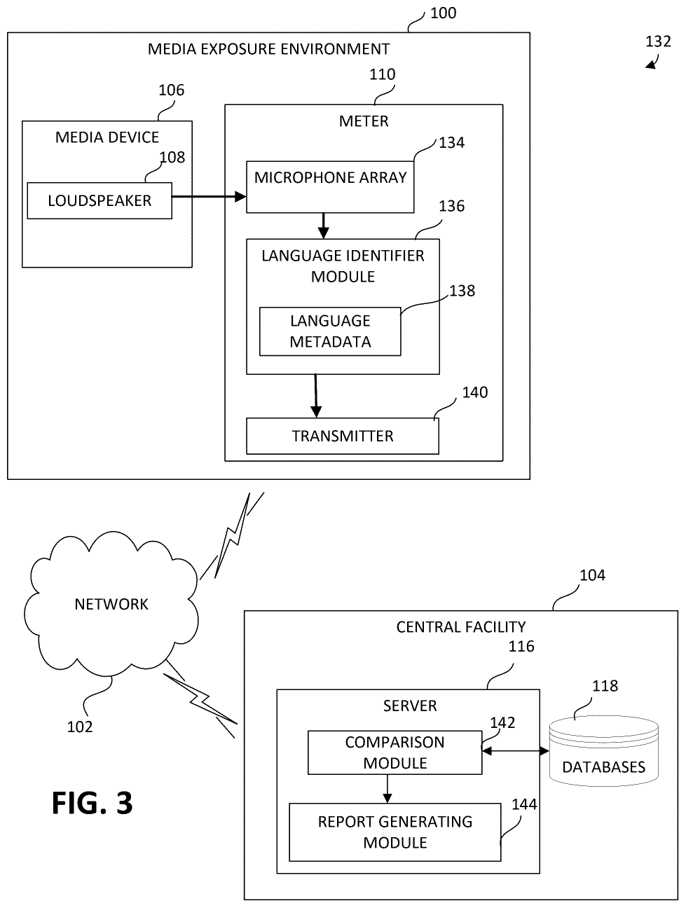

FIG. 3 is a simplified block diagram of an example system for creating language identifiers associated with media content using the meter 110 and crediting using the central facility 104, generally referred to by reference numeral, 132, in accordance with some aspects. Components in FIG. 3 in common with FIG. 1 are given the same reference numerals. Generally, the system 132 includes the media exposure environment 100 in communication, via the network 102, with the central facility 104. The media exposure environment 100 includes the media device 106 and the loudspeakers 108 operably coupled to the media device 106. The media exposure environment 100 also includes the meter 110. The meter 110 includes a microphone array 134, a language identifier module 136, language metadata 138, and a transmitter 140. The central facility 104 includes the server 116 includes a comparison module 142 and a report generating module 144. The databases 118 is in communication with the comparison module 142 of the server 116. The arrows in FIG. 3 depict direct communication from one component to another component. For example, the arrows can show the transfer of audio signals and/or data from one component to another component.

In some instances, the audio signal indicated by the arrow from the loudspeaker 108 to the microphone array 134 is a single audio signal received by the microphone array 134. In other examples, the audio signal is a plurality of audio signals. In some aspects, the audio signal has a duration of a few seconds (e.g., two seconds, four seconds, or six seconds).

In one or more aspects, the microphone array 134 can be in a variety of shapes and/or configurations. For example, the microphone array 134 can be a rectangular shape, a triangular shape, a square shape, or a circular shape. The microphone array 134 can include a plurality of microphones, which can be in a variety of configurations. The number of microphones of the microphone array 134 can vary. In some instances, the microphone array 134 includes at least two microphones. In several instances, the microphone array 134 can be a two-dimensional array. In other instances, the microphone array 134 can be a three-dimensional array. The microphone array 134, in some aspects, is a set of digital microphones. In other aspects, the microphone array 134 is a set of analog microphones.

In some aspects, the language identifier module 136 is software programmed in the meter 110 to identify a language of the signature. The language identifier module 136 can identify a primary language and a secondary language. For example, the language identifier module 136 can identify a first signature associated with a media content as being in Spanish and a second signature associated with a media content being in English. The language identifier module 136 can identify a plurality of languages (two, five, ten, twenty, etc.) and can assign a plurality of language identifiers. The language identifier module 136 can up-dated via software to identify additional languages. The language identifier module 136 can use speech-to-text conversion, pattern matching, signature analysis, and/or machine learning, as described herein, to identify a language of the signature. Identifying a language of the signature can include identifying a language identifier associated with the identified language.

In various aspects, the language metadata 138 is added to the signature. The language metadata can include a timestamp, the language identifier, and the like. The timestamp can be the timestamp when the audio signal was played by the loudspeaker 108. The timestamp can correspond to the portion of the signature having the language identifier. Additionally or alternatively, the timestamp can be when the language identifier module identifies or assigns the language identifier. The language identifier can be a code, reference, or the like that identifies the language of the audio signal. The language identifier embedded in the language metadata 138 can be compared to a database (such as one of the databases 118) at the central facility 104 to determine the language of the media content corresponding to the signature.

The transmitter 140 can be a Wi-Fi transmitter, a Bluetooth® transmitter, a BLE transmitter, or a similar wireless transmitter.

In various aspects, the comparison module 142 of the server 116 of the central facility 104 receives the signature with the language metadata 138 from the transmitter 140. The comparison module 142 can be software programmed on the server 116.

In one or more aspects, the report generating module 144 is in communication with the comparison module 142. The report generating module 144 can output a report that corresponds to media exposure of an audience. The report generating module 144 can output a report used for crediting. The report generating module 144 can also receive demographic information associated with the media exposure from a third-party database or from a database such as the databases 118 that is in communication with the server 116 having anonymized demographics (including the user 114). The report generating module 144 can output media exposure information including generalized demographic information (e.g., males, ages 18-25 were 24% of the streamed TV show Andor). The report generating module 144 can output media exposure information based on the language of the media content (e.g., 72% of the audience watched the TV show in the English language format, and 28% of the audience watched the TV show dubbed in Spanish).

In some aspects, the server 116 includes a receiver to receive data (such as the signature with the language metadata 138) from the transmitter 140.

In operation, the media device 106 is turned on in the media exposure environment 100 (such as a living room). A user such as the user 114 selects media content to watch on the media device 106. The media device 106 begins playing the media content and the audio signals associated with the media content are played over the loudspeakers 108. The audio signal transmitted by the loudspeakers 108 are picked up by the microphone array 134 of the meter 110, which is located within the media exposure environment 100. The microphone array 134 transmits the audio signal to one or more modules for audio processing. In particular, a signature is generated from the audio signal and transmitted to the language identifier module 136 to determine what language corresponds to the media content. Once a language is identified using the language identifier module 136, the signature is tagged with language metadata 138. The language metadata 138 is associated with the language using the language identifier which is identified by the language identifier module 136. The signature and the language metadata 138 are transmitted by the transmitter 140, via the network 102, to the server 116 of the central facility 104. The server 116 includes a comparison module 142 that receives the signature with the language metadata 138, determines the language of the signature using the language metadata 138, based on a determination of the language, communicates with a database of the databases 118, and compares the signature to one or more reference signatures in the database of the databases 118 to determine a match. Once a match has been determined, the media content associated with the media device 106 can now be identified using the reference signature and the media content can be credited. The report generating module 144 can credit media exposure of the media content based on the match determined by the comparison module 142.

In one or more aspects, the system 132 includes additional modules, components, sub-systems, and the like for audio processing. The meter 110 can include these additional components, or the server 116 can include these additional modules for audio processing. For example, the meter 110 can include additional components or modules to reduce ambient noise or to smooth the audio signal from the loudspeaker 108.

In various aspects, the language identifier module 136 identifies one or more languages associated with a media content. The language identifier module 136 can determine the language of the media content in an interval of time (e.g., every five seconds, every six seconds, every ten seconds.) The language identifier module 136 can tag one media content with only one type of language identifier. In other aspects, the language identifier module 136 can tag the media content with multiple types of language identifiers (such as a language identifier corresponding to English and one corresponding to Danish). In some aspects, the language identifier module 136 does not tag the media content with a language identifier until a change in type of language identifier occurs. In yet other aspects, the language identifier module 136 can tag the media content at every interval (such as six seconds) or each time a signature is generated regardless if the language identifier changed. For example, the first signature corresponding to the media content can have a language identifier for English, and the second signature corresponding to the media content can also have a language identifier for English, and so on. The language identifier module 136 can determine a language and tag the signature with language metadata 138 based on the determined language.

In some aspects, the comparison module 142 is one or more modules and/or operating on a plurality of servers configured to: receive the signature with the language metadata 138, identify a language corresponding to the language metadata 138, and compare the signature to one or more reference signatures of a database of the databases 118 that corresponds to the identified language. The reference signatures are each associated with media content, and the database of the databases 118 can include data associated with the reference signatures (such as language identifier, title of program, length of program, etc.). The comparison module 142 compares the one or more reference signatures stored in the databases 118 based on the language metadata 138. For example, the comparison module 142 can identify using the language metadata 138 that the media content is in French, and based on that identification, only search databases of the databases 118 with French references. The databases 118 can be separated by language features such as media content in Korean, media content having two languages present, and the like. The databases 118 can also include language identifiers associated with the reference signatures and look for a match between the language identifier of the signature and the language identifier of the reference signature prior to comparing the two. The comparison module 142 can output a reference signature that matches the signature sent from the meter 110. Alternatively, when there is a match between the audio signal and a reference audio signal, the comparison module 142 can output data associated with the reference signature such as the title of the program.

In one or more aspects, the report generating module 144 generates audience exposure metrics. In some aspects, the report generating module 144 credits media based on match results of the comparison module 142.

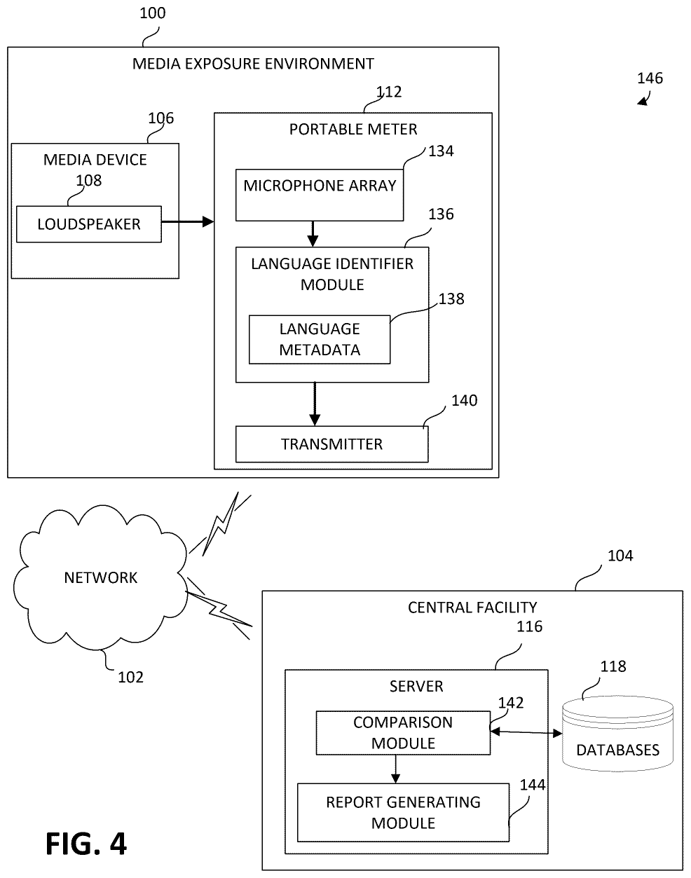

FIG. 4 is a simplified block diagram of an example system for creating language identifiers associated with media content using the portable meter 112 and crediting using the central facility 104, generally referred to by reference numeral, 146, in accordance with some aspects. Components in FIG. 4 in common with FIGS. 1 and 3 are given the same reference numerals. Generally, the system 146 includes the media exposure environment 100 in communication, via the network 102, with the central facility 104. The media exposure environment 100 includes the media device 106 and the loudspeakers 108 operably coupled to the media device 106. The media exposure environment 100 also includes the portable meter 112. The portable meter 112 includes the microphone array 134, the language identifier module 136, language metadata 138, and the transmitter 140. The central facility 104 includes the server 116 includes a comparison module 142 and a report generating module 144. The databases 118 is in communication with the comparison module 142 of the server 116. The arrows in FIG. 3 depict direct communication from one component to another component. For example, the arrows can show the transfer of audio signals and/or data from one component to another component.

In some aspects, the portable meter 112 is a part of and/or operationally coupled to the media device 106. For example, the portable meter 112 can be a software application on the media device 106. The portable meter 112 can use the microphone array 134 on the media device 106 or base the analysis on the audio signal transmitted by the loudspeaker 108.

In operation, the media device 106 is turned on in the media exposure environment 100 (such as a restaurant). A user such as the user 114 watches media content on the media device 106. The media device 106 begins playing the media content and the audio signals associated with the media content are played over the loudspeakers 108. The audio signal transmitted by the loudspeakers 108 are picked up by the microphone array 134 of the portable meter 112, which is located within the media exposure environment 100. The microphone array 134 transmits the audio signal to one or more modules for audio processing. In particular, the audio signal is used to generate a signature. The signature is transmitted to the language identifier module 136 to determine what language corresponds to the media content. Once a language is identified using the language identifier module 136, the signature is tagged with language metadata 138. The language metadata 138 is associated with the language identified by the language identifier module 136. The signature and the language metadata 138 are transmitted by the transmitter 140, via the network 102, to the server 116 of the central facility 104. The server 116 includes a comparison module 142 that receives the signature with the language metadata 138, determines the language of the signature using the language metadata 138, based on a determination of the language, communicates with a database of the databases 118, and compares the signature to one or more reference signatures in the database of the databases 118 to determine a match. Once a match has been determined, the media content associated with the media device 106 can now be determined using the reference signature and the media content can be credited. The report generating module 144 can credit media exposure of the media content based on the match determined by the comparison module 142.

In some aspects, the portable meter turns on and begins collecting audio content when the portable meter 112 is near a media device 106 producing audio signals in a media exposure environment 100.

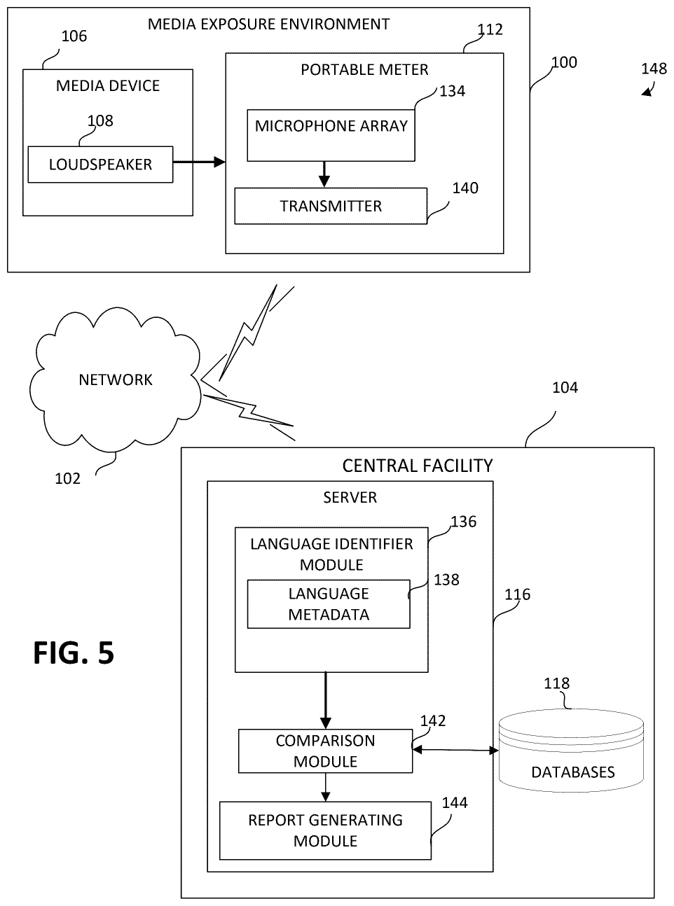

FIG. 5 is a simplified block diagram of an example system for creating language identifiers associated with media content and crediting media exposure associated with the media content using the central facility 104, generally referred to by reference numeral, 148, in accordance with some aspects. Components in FIG. 4 in common with FIGS. 1, 3, and 4 are given the same reference numerals. Generally, the system 148 includes the media exposure environment 100 in communication, via the network 102, with the central facility 104. The media exposure environment 100 includes the media device 106 and the loudspeakers 108 operably coupled to the media device 106. The media exposure environment 100 also includes the portable meter 112. The portable meter 112 includes the microphone array 134 and the transmitter 140. The central facility 104 includes the server 116 includes a language identifier module 136, language metadata 138, comparison module 142, and a report generating module 144. The databases 118 is in communication with the comparison module 142 of the server 116. The arrows in FIG. 3 depict direct communication from one component to another component. For example, the arrows can show the transfer of audio signals and/or data from one component to another component.

In some aspects, the portable meter 112 is replaced by the meter 110. In other aspects, one or more portable meters 112 and/or a meter 110 is within the media exposure environment 100.

In one or more aspects, the server 116 includes a plurality of servers configured to run a plurality of modules including the language identifier module 136, the comparison module 142, and/or the report generating module 144. The databases 118 can be in communication with one or more servers of the plurality of servers.

In operation, the media device 106 is turned on in the media exposure environment 100 (such as a theater). A user such as the user 114 watches media content on the media device 106. The media device 106 begins playing the media content and the audio signals associated with the media content are played over the loudspeakers 108. The audio signals transmitted by the loudspeakers 108 are picked up by the microphone array 134 of the portable meter 112, which is located within the media exposure environment 100. The portable meter 112 generates a signature using an audio signal of the audio signals. The signature is transmitted, using the transmitter 140, and via the network 102 to the central facility 104. At the central facility, the signature is input to the language identifier module 136 to determine what language corresponds to the media content. Once a language is identified using the language identifier module 136, the signature can be tagged with language metadata 138. The language metadata 138 is associated with the language identified by the language identifier module 136. The signature and the language metadata 138 are sent to the comparison module 142. The comparison module 142 determines the language of the signature using the language metadata 138, based on a determination of the language, communicates with a database of the databases 118, and compares signature to one or more reference signatures in the database of the databases 118 to determine a match. Once a match has been determined, the media content associated with the media device 106 can now be determined using the reference signature, and the media content can be credited. The report generating module 144 can credit media exposure of the media content based on the match determined by the comparison module 142.

In this aspect, a majority of the audio processing occurs at the central facility 104, instead of at the meter 110 or the portable meter 112. This reduces the processing power and time needed at the meter 110 or the portable meter 112.

Referring to FIGS. 2-5, it is understood that this exemplary division and relationship between the modules can be modified without departing from the scope or spirit of the present invention. Additionally, function can be distributed across several modules.

### III. Example Operations

The computing system 120 and/or components thereof can be configured to perform and/or can perform one or more operations. Examples of these operations and related features will now be described.

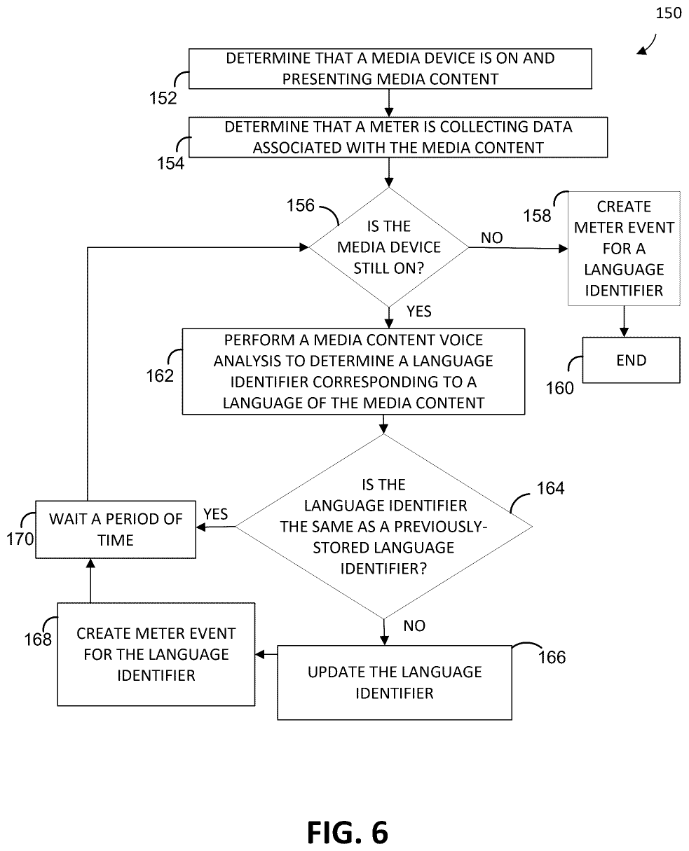

Referring to FIG. 6, with continuing reference to FIG. 3, a method 150 for creating language identifiers associated with media content using the meter 110 is described. Method 150 is illustrated as a set of operations or blocks 152 through 170. Not all of the illustrated blocks 152 through 170 can be performed in all aspects of method 150. One or more blocks that are not expressly illustrated in FIG. 6 can be included before, after, in between, or as part of the blocks 152 through 170. In some aspects, one or more of the blocks 152 through 170 can be implemented, at least in part, by the computing device 120 and/or the meter 110 in the form of executable code stored on non-transitory, tangible, machine-readable media that when run by one or more processors can cause the one or more processors to perform one or more of the processes. In one or more aspects, the blocks in method 150 are performed within a computing system, as described herein.

In an example aspect, the method 150 includes determining that a media device is ON and presenting media content at a block 152; determining that a meter is collecting data associated with the media content at a block 154; determining if the media device is still ON at a block 156; if the media device is not ON, creating a meter event for a language identifier at a block 158 and ending the method 150 at a block 160 until the media device is turned on again; and if the media device is ON, performing a media content voice analysis to determine a language identifier corresponding to a language of the media content at a block 162; determining if the language identifier is the same as a previously-stored language identifier at a block 164; if the language identifier is different than the previously-stored language identifier, then updating the language identifier at a block 166; creating a meter event for the language identifier at a block 168, and waiting a period of time at a block 170 before proceeding to the block 156; and if the language identifier is the same as the previously-stored language identifier, then proceeding to the block 170 before proceeding to the block 156.

In some aspects, the block 152 includes receiving a media or audio signal from the media device. The block 152 can include receiving information from the media device or a separate device such as a set-top box in communication with the media device that includes ON/OFF information of the media device. The media device can be the media device 106. The block 152 can be satisfied if the meter receives audio signals from the media device or from a loudspeaker such as the loudspeaker 108 operatively coupled to the media device. The block 152 can include a meter such as the meter 110 identifying watermarks, codes, signatures, and the like.

In one or more aspects, the block 154 is combined with the block 152. For example, the meter can pick up a watermark, code, signature, or the like and simultaneously determine that the media device is ON and that the meter is collecting data associated with the media content. The block 154, in other embodiments, is separate from the block 152. The block 154 can determine that the meter is collecting data when the microphone or microphone array such as microphone array 134 of the meter is ON and collecting audio signals. The block 154 can determine that the meter is collecting data when the microphone or microphone array is collecting watermarks and signatures. The meter can be the meter 110.

In various aspects, the meter can determine that the media device is still ON and presenting media content at the block 156. The meter can determine that the media device is in an ON-state when its microphone array is still collecting audio signals. The meter can determine that the media device is in an ON-state when the audio signals contain watermarks. The meter can determine that the media device is in an ON-state when signatures are generated from the audio signals. The meter can receive information from the media device or a device operatively coupled to the media device that indicates that the status of the media device is ON and presenting. The meter can collect data such as one or more audio signals, one or more media signals, watermarks, signatures, metadata, and the like.

In several aspects, if the media device is no longer presenting media and/or is turned off, then the block 158 creates a meter event for a language identifier that is stored in the meter to be later sent to a server associated with the AME. The block 158 can include collecting a signature of the audio signal from the media device, performing a media content voice analysis (as described below in the block 162), and storing the result of the media content voice analysis as a meter event for a language identifier. For example, the meter can collect a signature for an audio signal of the media device. The meter can perform a media content voice analysis on the signature and determine that the language of the signature corresponds to Spanish. The block 158 would then create the meter event for a language identifier (e.g., signature, timestamp, Spanish language identifier). The meter event of the block 158 can include the signature and metadata associated with the signature. The metadata can include a timestamp and a language identifier corresponding to the language of the signature (and the underlying media content). The metadata can include a plurality of timestamps. For example, one timestamp can be when the media was presented by the media device, and another timestamp can correspond to a portion of the audio signal analyzed for the media content voice analysis to determine the language identifier. The language identifier module 136 at the block 158 can generate metadata (such as language metadata 138). Creating the meter event for the language identifier can be creating metadata associated with the audio signal of the media device for the portion corresponding to the signature.

In some aspects, the block 158 can create the meter event for the language identifier by setting a default language identifier for the meter event. For example, a user (such as the user 114) or a meter technician can set a primary language of the meter as a default. The primary language could correspond to the primary language of the country where the meter is located. Alternatively, the primary language can correspond to the primary language of the household. The meter event for the language identifier at the block 158, in some aspects, is the previously-stored language identifier of the block 164.

At the block 160, the method 150 ends until the next instance when the media device is turned ON and presenting. When the media device is turned ON and presenting, the method 150 begins again at the block 152.

At the block 162, if the media device is still ON and/or presenting the media content, then the media content voice analysis is performed by the meter, such as the meter 110. The media content voice analysis can be software or software modules programmed in the meter (such as the language identifier module 136 described herein). The media content voice analysis can use speech-to-text conversion, also referred to herein as, voice-to-text analysis to determine a language identifier. The media content voice analysis can use a collected signature of the meter, determine using voice-to-text analysis characteristics (such as vibrations, pitch, duration, phonemes, Mel-Frequency Cepstral Coefficients, etc.) of the audio signal, analyze the characteristics of the audio signal, and determine a language of the audio signal (and the underlying media content). Analyzing the characteristics of the audio signal can include matching phonemes and using pattern recognition to determine a most probable language from the voice-to-text analysis so that the language identifier can be determined and/or selected based on the most probable language. Analyzing the characteristics of the audio signal can include using machine learning, artificial intelligence, or natural language processing to determine a most probable language identifier from the voice-to-text analysis. For example, natural language processing can be used to analyze sentence structure and grammar to determine the language associated with the signature so that the language identifier can be determined and selected. Analyzing the characteristics of the audio signal can include using signature analysis to determine a most probable language and determine the language identifier based on the most probable language. The media content voice analysis determines the language of the underlying media content at a particular time. For example, a movie can be primarily in German but include a scene in the movie can be in Japanese. Therefore, one signature for the same movie can have a language identifier of Japanese, while the other signatures can have a language identifier of German. The block 162 can use a previously-stored language identifier as a default to determine first if the language of the media content corresponds to the previously-stored language identifier to help speed up the processing of the media content voice analysis.

In various aspects, the block 164, the language identifier output by the media content voice analysis and/or the language identifier module 136 is compared to a previously-stored language identifier. The previously-stored language identifier can be stored in the meter. The previously-stored language identifier can be the language identifier from the block 158. The previously-stored language identifier can be the last language identifier identified by the media content voice analysis. The previously-stored language identifier, in some aspects, corresponds to a different presentation of media content. In other aspects, the previously-stored language identifier corresponds to the same presentation of media content. The previously-stored language identifier can correspond to the same presentation of media content, and yet still be a different language identifier.

In some aspects, the block 166 occurs automatically in response to determining that the language identifier is different from the previously-stored identifier. The block 166 can include storing the language identifier to replace to previously-stored language identifier. The stored language identifier can now be the default language identifier of the meter. The default language can be used in the next media content voice analysis.

In one or more aspects, the block 168 can include the block 166. The block 168 can occur automatically in response to the block 166 or the block 164. The block 164 creates a meter event for the language identifier to be stored in the meter to be later sent to a server (such as the server 116) associated with the AME. The meter event of the block 168 and/or the block 164 can be performed as part of the language identifier module 136. The language identifier module 136 at the block 168 can generate metadata (such as language metadata 138). The metadata can include a timestamp and a language identifier corresponding to the language of the signature (and the underlying media content). The metadata can include a plurality of timestamps. For example, one timestamp can be when the media was presented by the media device, and another timestamp can correspond to a portion of the audio signal analyzed for the media content voice analysis to determine the language identifier. Creating the meter event for the language identifier can be creating metadata associated with the audio signal of the media device for the portion corresponding to the signature. The block 168 can create the meter event for the language identifier by storing the language identifier.

In various aspects, the block 170 occurs after the block 164 if the language identifier is the same as the previously-stored language identifier. The block 170 can also occur after the block 168. The meter can be programmed to wait a period of time before returning to the block 156 to determine if the media device is still ON and presenting media content. The period of time can be five minutes. In other aspects, the period of time can be eight, ten, or fifteen minutes. The meter includes a timer component configured to determine when the period of time has passed and proceeds to the block 156.

The method 150 ends when the media device is no longer ON and no longer presenting media. However, the method 150 begins again when the media device is powered ON and presenting media content again.

The method 150 can include transmitting the signatures and the metadata (such as the language metadata 138) from the meter to a server of the AME (such as the server 116) in order to compare the signature to one or more reference signatures of a database of reference signatures for crediting.

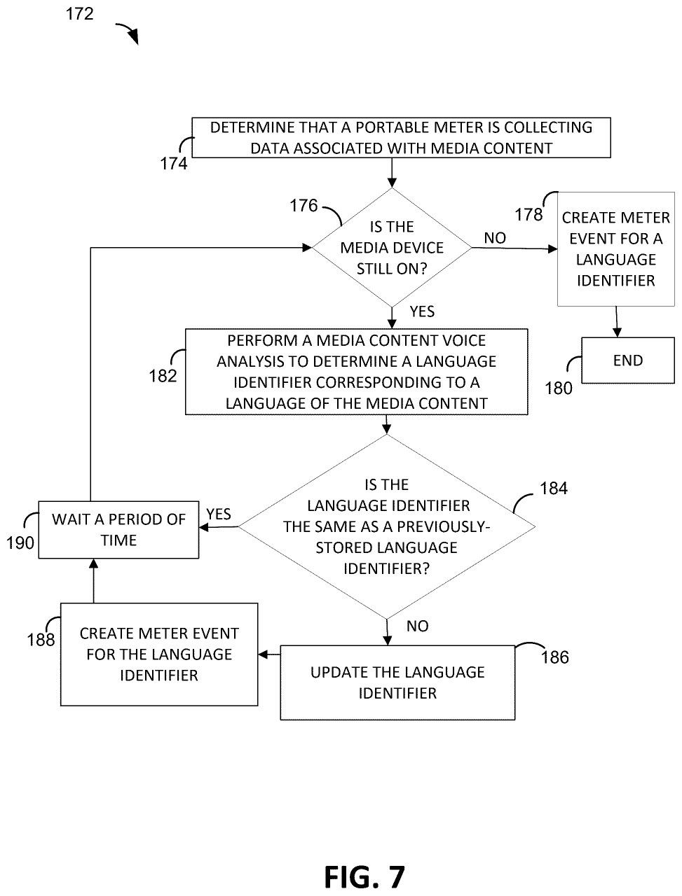

Referring to FIG. 7, with continuing reference to FIG. 4, a method 172 for creating language identifiers associated with media content using the portable meter 112 is described. Method 172 is illustrated as a set of operations or blocks 174 through 190. Not all of the illustrated blocks 174 through 190 can be performed in all aspects of method 172. One or more blocks that are not expressly illustrated in FIG. 7 can be included before, after, in between, or as part of the blocks 174 through 190. In some aspects, one or more of the blocks 174 through 190 can be implemented, at least in part, by the computing device 120 and/or the portable meter 112 in the form of executable code stored on non-transitory, tangible, machine-readable media that when run by one or more processors can cause the one or more processors to perform one or more of the processes. In one or more aspects, the blocks in method 172 are performed within a computing system, as described herein.

In an example aspect, the method 172 includes determining that a portable meter is collecting data associated with media content at a block 174; determining if the media device is still ON at a block 176; if the media device is not ON, creating a meter event for a language identifier at a block 178 and ending the method 172 at a block 180 until the media device is turned on again; and if the media device is ON, performing a media content voice analysis to determine a language identifier corresponding to a language of the media content at a block 182; determining if the language identifier is the same as a previously-stored language identifier at a block 184; if the language identifier is different than the previously-stored language identifier, then updating the language identifier at a block 186; creating a meter event for the language identifier at a block 188, and waiting a period of time at a block 190 before proceeding to the block 176; and if the language identifier is the same as the previously-stored language identifier, then proceeding to the block 190 before proceeding to the block 176.

In some aspects, at the block 174, determining that the portable meter is collecting data associated with media content can include determining that the portable meter is ON. Determining that the portable meter is collecting data associated with media content can include at least one of: determining that the portable meter is charged at a level that permits collecting of data or determining that the portable meter is receiving one or more audio signals, one or more media signals, metadata, watermarks, signatures, and the like associated with media content.

In several aspects, the blocks 178, 182, 184, 186, 188, and/or 190 are performed by the portable meter 112. In particular, in some aspects, the language identifier module 136 of the portable meter 112 performs the blocks 178, 182, 184, 186, 188, and/or 190.

The method 172 ends when the media device is no longer ON and no longer presenting media. However, the method 172 begins again when the media device is powered ON and presenting media content again.

The method 172 can include transmitting the signatures and the metadata (such as the language metadata 138) from the portable meter to a server of the AME (such as the server 116) in order to compare the signature to one or more reference signatures of a database of reference signatures for crediting.

In some aspects, the method 172 of FIG. 7 can illustrate portions of blocks 152 and 156-170 of method 150 of FIG. 6.

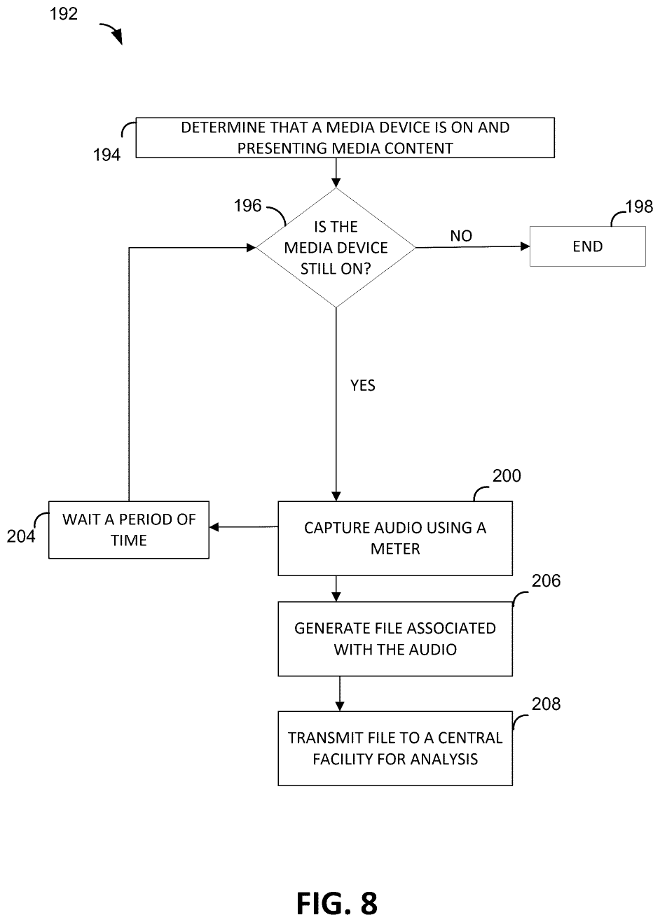

Referring to FIG. 8, with continuing reference to FIG. 5, a method 192 for collecting audio using a meter in order to create language identifiers using the central facility 104 is described. Method 192 is illustrated as a set of operations or blocks 194 through 208. Not all of the illustrated blocks 194 through 208 can be performed in all aspects of method 192. One or more blocks that are not expressly illustrated in FIG. 8 can be included before, after, in between, or as part of the blocks 194 through 208. In some aspects, one or more of the blocks 194 through 208 can be implemented, at least in part, by the computing device 120, the meter 110, and/or the portable meter 112 in the form of executable code stored on non-transitory, tangible, machine-readable media that when run by one or more processors can cause the one or more processors to perform one or more of the processes. In one or more aspects, the blocks in method 192 are performed within a computing system, as described herein.

In an example aspect, the method 192 includes determining that a media device is ON and presenting media content at a block 194; determining if the media device is still ON at a block 196; if the media device is not ON, then ending the method 192 at a block 198; if the media device is ON, then capturing audio using a meter at a block 200; waiting a period of time at a block 204 before proceeding to the block 196; after the block 200, generating a file associated with the audio at a block 206; and transmitting a file to a central facility for analysis at a block 208.

In some aspects, the block 194 includes receiving a media or audio signal from the media device. The block 194 can include receiving information from the media device or a separate device such as a set-top box in communication with the media device that includes ON/OFF information of the media device. The media device can be the media device 106. The block 194 can be satisfied if the meter receives audio signals from the media device or a loudspeaker such as the loudspeaker 108 operatively coupled to the media device. The block 194 can include a meter such as the meter 110 identifying watermarks, codes, signatures, and the like. The block 194 can determine that the media device is ON and presenting media content when that the meter is collecting data associated with the media content. For example, the block 194 can determine that the media device is ON and presenting media content when the meter (such as the meter 110 or the portable meter 112) is collecting data such as watermarks or signatures using the microphone or microphone array of the meter.

In various aspects, at the block 196, the meter can determine that the media device is still ON and presenting media content. The meter can determine that its microphone array is still collecting audio signals. The meter can determine that the audio signals contain watermarks. The meter can collect signatures from the audio signals. The meter can receive information from the media device or a device operatively coupled to the media device that indicates that the status of the media device is ON and presenting. The meter can collect data such as one or more audio signals, one or more media signals, watermarks, signatures, metadata, and the like. The meter can be the portable meter 112 and/or the meter 110.

In some aspects, the method 192 ends at the block 198 when the meter determines the media device is OFF. The method 192 can also end at the block 198 when the media device is turned ON but not presenting media. The method 192 can end at the block 198 when the media device is not transmitting audio signals detectable by the meter (i.e., the media device is muted or on low volume).

In several aspects, the block 200 occurs automatically in response to determining that the media device is still ON at the block 196. In some aspects, the block 200 is combined with the block 196 and capturing audio using a meter indicates that the media device is still ON. The block 200 can include collecting signatures from the audio using the meter. The block 200 can include detecting one or more watermarks from the audio using the meter.

In one or more aspects, the block 204 occurs after the block 200 or the block 206. At the block 204, the meter waits a period of time before determining if the media device is still ON and presenting at the block 196. The period of time can be four seconds, six seconds, ten seconds, or the like. The period of time can be longer such as five minutes. The block 200 can be occurring simultaneously to the block 204.

In various aspects, the block 206 includes generating a small file associated with the audio. The small file can include media events, signatures, timestamps, watermarks, audio signals, metadata not associated with language identifiers, and the like. The file generated at the block 206 can be stored in the meter for later transmission.

In one or more aspects, the block 208 is omitted. The block 208 can occur after a set period of time or a set amount of data is stored by the meter to be sent to the central facility. The central facility can be the central facility 104. For example, the portable meter 112 can transmit to the central facility 104 twice a day. In other aspects, the block 208 can transmit files throughout the day to the central facility over a network such as the network 102 for creating language identifiers and further crediting at the central facility. The block 208 can transmit the file to a server of the central facility, such as the server 116. The block 208 can transmit the file to the server 116 to be stored in a database until the file is to be processed by the server 116.

The method 192 can end when the media device is no longer ON and no longer presenting media. However, the method 192 can begin again when the media device is powered ON and presenting media content again.

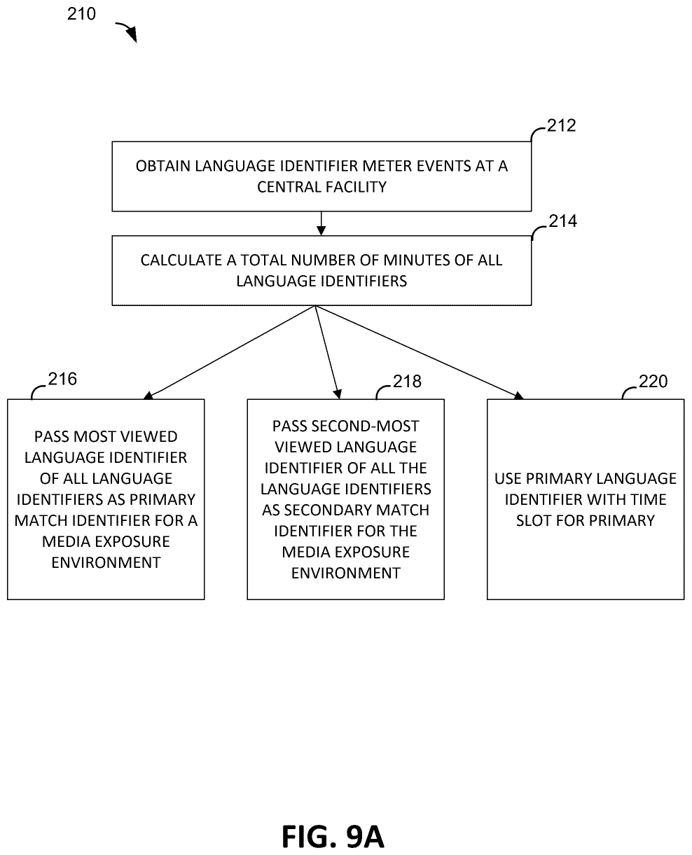

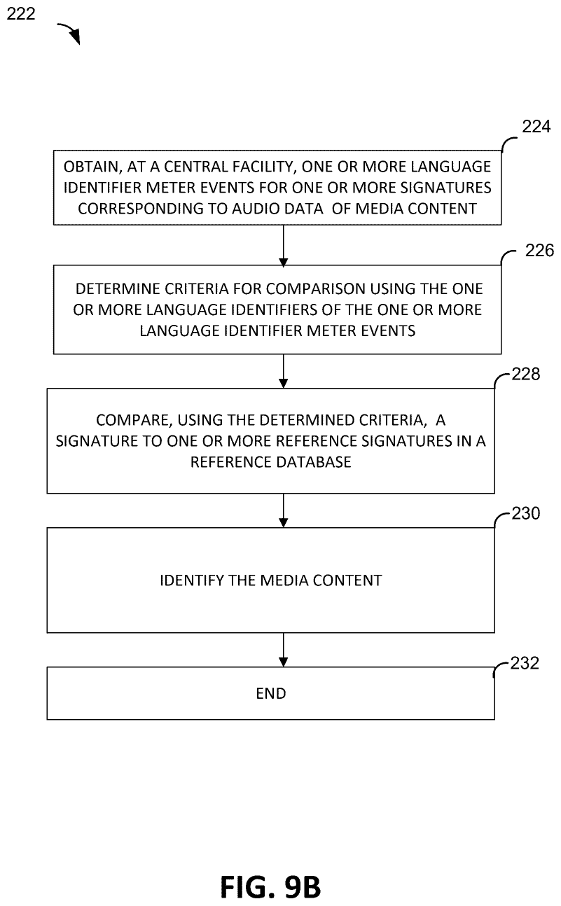

Referring to FIG. 9A, with continuing reference to FIGS. 6-8, a method 210 for determining a primary language of the media content using the central facility 104 is described. Method 210 is illustrated as a set of operations or blocks 212 through 220. Not all of the illustrated blocks 212 through 220 can be performed in all aspects of method 210. One or more blocks that are not expressly illustrated in FIG. 9A can be included before, after, in between, or as part of the blocks 212 through 220. In some aspects, one or more of the blocks 212 through 220 can be implemented, at least in part, by the computing device 120, the central facility 104, or the server 116 in the form of executable code stored on non-transitory, tangible, machine-readable media that when run by one or more processors can cause the one or more processors to perform one or more of the processes. In one or more aspects, the blocks in method 210 are performed within a computing system, as described herein.

In an example aspect, the method 210 includes obtaining language identifier meter events at a central facility at a block 212, calculating a total number of minutes of all language identifiers at a block 214, passing most viewed language identifier of all language identifiers as primary match identifier for a media exposure environment at a block 216, passing a second-most viewed language identifier of all the language identifiers as secondary match identifier for the media exposure environment at a block 218; and using primary match identifier with time slot at a block 220.

At the block 212, in some aspects, the central facility receives language identifier meter events from the meter 110, as described in FIG. 6, as meter events. The central facility can be the central facility 104. The central facility can receive language identifier meter events from the portable meter 112, as described in FIG. 7, as meter events. The central facility can receive the meter events from a server, such as the server 116. In some aspects, the central facility, rather than the meter 110 or the portable meter 112, creates the meter event by tagging audio data with a language identifier, using the audio data sent from a meter to the server 116. The central facility can obtain language identifier meter events stored in a database in communication with the central facility, such as a database of the databases 118. The language identifier meter events can include data such as a language identifier, audio data, and a timestamp.

In one or more aspects, at the block 214, a server of the central facility such as the server 116 is configured to calculate a total number of minutes of all language identifiers sent from a meter. The total number of minutes of all language identifiers can be for a single program associated with the media content such as a television program or a movie. In other aspects, the total number of minutes of all language identifiers can be for a period of time such as over thirty minutes, an hour, twenty-four hours, thirty-six hours, and the like. The total number of minutes can be calculated by using the timestamps in the meter events. For example, a first meter event can have a language identifier as Spanish at time 1:00; a second meter event can have a second language identifier as Spanish at time 1:05; a third meter event can have a third language identifier as English at time 1:10; and a fourth meter event can have a fourth language identifier as Spanish at time 1:15. The total number of minutes can be calculated. The timestamps of the meter event are used to calculate the total number of minutes at the block 214 by summing the time for each language identifier. For this example, the total number of minutes in Spanish exceeds that of English. Therefore, the Spanish language identifier would be passed to the block 216 and the block 220; and the English language identifier would be passed to the block 218.

In some aspects, at the block 214, the number of language identifiers over a period of time are added together. For example, a first meter event can have a language identifier as Spanish at time 3:00; a second meter event can have a second language identifier as Spanish at time 3:15; a third meter event can have a third language identifier as English at time 3:25; and a fourth meter event can have a fourth language identifier as Spanish at time 4:15. In this example, there were three Spanish language identifiers to one English language identifier. Therefore, the Spanish language identifier would be passed to the block 216 and the block 220; and the English language identifier would be passed to the block 218.

In several aspects, at the block 216, the most-viewed language identifier is tagged as a primary match identifier for a media exposure environment, such as the media exposure environment 100. The most-viewed language identifier is tagged as a primary match identifier for a period of time, in other aspects, such as for a period of thirty minutes, an hour, twenty-four hours, or the like. Therefore, the primary match can correlate to a particular program like a television show or can correlate to a whole set of data sent from the meter. The primary match identifier can be tagged to the audio data corresponding to the media content. The primary match identifier can replace all the language-identifiers used to calculate the total number of minutes in the block 214. The primary match identifier can be stored in a database and associated with the audio content from the media device, so that when the audio data is compared to a reference database such as one of the databases 118, the primary match identifier can be used to compare to a reference database with the same primary identifier. The primary match identifier can correspond to a particular reference database that has the same primary language.

In various aspects, at the block 218, the second-most viewed language identifier is tagged as a secondary match identifier for a media exposure environment, such as the media exposure environment 100. The second-most viewed language identifier is tagged as the secondary match identifier for a period of time, in other aspects, such as for a period of thirty seconds, two minutes, five minutes, or the like. Therefore, the secondary match can correlate to a particular program like an advertisement in a show or can correlate to a scene in a movie that is using a different language than the primary. The secondary match identifier can also be tagged to the audio data corresponding to the media content. The secondary match identifier can be stored in a database and associated with the audio content from the media device, so that when the audio data is compared to a reference database such as one of the databases 118, the primary and the secondary match identifiers can be used to compare to a reference database with the primary and secondary identifiers. The primary and secondary match identifiers can correspond to a particular reference database that has the same primary and secondary languages.

In some aspects, the block 218 is omitted. In other aspects, the block 218 is only used when the primary match identifier did not find a match in the reference database associated with the primary language.

In some aspects, the block 220 occurs after the block 216. In one or more aspects, the block 220 includes the block 216. The block 220 can use the primary match identifier from the block 216 and adds in the time or time slot. The block 220 can be used for crediting. The block 220 can be used to generate a report that identifies at least two of: the primary match identifier (primary language of the media content being viewed), time associated with the media content being viewed, or one or more signatures of the content being viewed.

Referring to FIG. 9B, with continuing reference to FIG. 9A, a method 222 for identifying media content using the language identifiers at the central facility is described. Method 222 is illustrated as a set of operations or blocks 224 through 232. Not all of the illustrated blocks 224 through 232 can be performed in all aspects of method 222. One or more blocks that are not expressly illustrated in FIG. 9B can be included before, after, in between, or as part of the blocks 224 through 232. In some aspects, one or more of the blocks 224 through 232 can be implemented, at least in part, by the computing device 120, the central facility 104, or the server 116 in the form of executable code stored on non-transitory, tangible, machine-readable media that when run by one or more processors can cause the one or more processors to perform one or more of the processes. In one or more aspects, the blocks in method 222 are performed within a computing system, as described herein.

In an example aspect, the method 222 includes obtaining, at a central facility, one or more language identifier meter events for one or more signatures corresponding to audio data of media content at a block 224, determining criteria for comparison using the one or more language identifiers of the one or more language identifier meter events at a block 226, comparing, using the determined criteria, a signature of the one or more signatures to one or more reference signatures in a reference database at a block 228; identifying the media content at a block 230; and ending at a block 232.

In various aspects, the block 224 is the same as the block 212 of FIG. 9A. The block 224 can receive one or more language meter events for one or more signatures corresponding to audio data of media content from a meter (such as meter 110) and/or a portable meter (such as the portable meter 112). The block 224 can receive one or more language meter events for one or more signatures corresponding to audio data of media content from a server or a database in communication with the server, such as the server 116. The one or more language meter events and their corresponding signatures can be stored in the database. The signatures can represent a snippet of audio data and have metadata associated with the signature that includes the language identifier and a timestamp. The central facility can be the central facility 104. The central facility can receive multiple language meter events for the same media content. The central facility can receive multiple language meter event for the same viewing session that includes viewing a plurality of media content. The central facility can receive a single language meter event for a media content such as when a user of the media device changes quickly from one channel to the next or views an advertisement one time.

At the block 226, in one or more aspects, the criteria for comparison are determined using one or more servers such as the server 116. The criteria for comparison can be at least one of the blocks 214-220 of FIG. 9A. For example, the criteria for comparison can be the total number of minutes, the primary match identifier, the secondary match identifier, the combination of the primary match identifier and the secondary match identifier, the primary language identifier with the time slot for primary, and the like. The block 226 can identify which language identifier of all language identifiers obtained is the most viewed language (e.g., the primary match identifier). The block 226 can calculate the total number of minutes using the timestamps associated with the language identifiers as the criteria for comparison, where the language identifier with the greatest number of minutes is selected as the determined criteria or primary match identifier.

In some aspects, the block 228 uses the determined criteria, such as the primary match identifier, to compare the signature from the meter to one or more reference signatures in a reference database. For example, if the determined criteria were the primary match identifier and the primary match identifier is associated with the French language, then the signature can be compared to one or more signatures having the same primary match identifier (French). The reference database can be a database of the databases 118. The reference database can include a plurality of references, where each reference is associated with a primary match identifier. Having both the signature and the plurality of reference signatures tagged with a primary match identifier creates a faster, more efficient way to search for a match in order to identify the media content, using less computing power and resources. Additionally, and/or alternatively, the reference database can be exclusively reference signatures having the same primary match identifier, which also creates a faster, more efficient way to search for a match in order to identify the media content. The determined criteria used for the comparison in the block 228 can also be the secondary match identifier. In some aspects, when the signature is compared to one or more reference signatures in a reference database associated with the primary match identifier results in no matches, the determined criteria is the secondary match identifier. The signature is compared to one or more reference signatures associated with the secondary match identifier. In one or more aspects, the primary and the secondary match identifiers are used to compare the signature to one or more reference signatures in a reference database having the same primary and secondary match identifiers.

In various aspects, after comparing at block 228, the media content of the signature can be identified based on a match between the reference signature and the signature. With this match, the media content of the signature can be identified as the same media as represented by the reference signature. The block 232 can include generating and outputting the media content in a report. The block 232 can include crediting media as having been watched by the user 114.

In various aspects, once the match is determined at the block 230, the media content of the signature can be identified, since the media content of the reference signature is known. The block 230 can include generating and outputting the media content in a report. The block 230 can include crediting media as having been watched by the user 114.

In some aspects, the block 232 can include crediting media as having been watched by the user 114. The block 232 can include generating and outputting the media content in a report. The method 222 can begin again when one or more language identifier meter events are obtained. The block 232 can include crediting media as having been watched by the user 114. The block 232 can include generating and outputting the media content in a report.

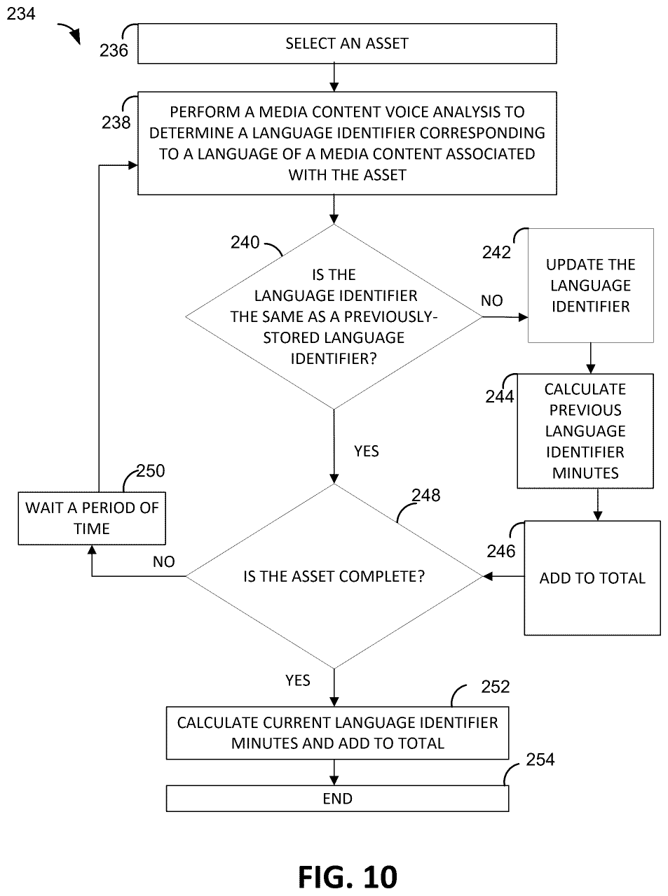

Referring to FIG. 10, with continuing reference to FIGS. 5 and 8, a method 234 for identifying media content using the language identifiers at the central facility 104 is described. Method 234 is illustrated as a set of operations or blocks 236 through 254. Not all of the illustrated blocks 236 through 254 can be performed in all aspects of method 234. One or more blocks that are not expressly illustrated in FIG. 10 can be included before, after, in between, or as part of the blocks 236 through 254. In some aspects, one or more of the blocks 236 through 254 can be implemented, at least in part, by the computing device 120 and the central facility 104, including the server 116 and the databases 118, in the form of executable code stored on non-transitory, tangible, machine-readable media that when run by one or more processors can cause the one or more processors to perform one or more of the processes. In one or more aspects, the blocks in method 234 are performed within a computing system, as described herein.

In an example aspect, the method 234 includes selecting an asset at a block 236; performing a media content voice analysis to determine a language identifier corresponding to a language of media content associated with the asset at a block 238; determining if the language identifier is the same as a previously-stored language identifier at a block 240; if the language identifier is not the same as the previously-stored language identifier, then update the language identifier at a block 242; then proceed to a block 244, to calculate previous language identifier minutes; then proceed to a block 246 to add the previous language identifier minutes to the total; then proceed to a block 248, determining if the asset is complete; if the language identifier is the same as the previously-stored language identifier in the block 240, it also proceeds to the block 248; if the asset is not complete, then wait a period of time at a block 250, before proceeding to the block 238; if the asset is complete, then proceeding to a block 252 to calculate current language identifier minutes and add to total; and then end the method 234 at a block 254.

In some aspects, at the block 236, the method 234 can use an asset sent from a meter (such as the meter 110) or a portable meter (such as the portable meter 112). The asset can be associated with a media content. The asset can be audio data such as a signature or a plurality of signatures. The audio data can correspond to audio data associated with media content presented on a media device (such as the media device 106 or the loudspeakers 108). The central facility 104 can determine the language identifier of the signature rather than the meter. For instance, at the block 236, an asset can be a first signature for analysis from a plurality of signatures sent from a meter. In other instances, at the block 236, the asset can be a first signature for analysis from a database in communication with a server.

In other aspects, at the block 236, the method 234 can use an asset from a reference database. The asset can be one or more reference signatures associated with the same media content. The reference signatures correspond to audio data such as audio snippets where the audio data corresponds to media content that is known. The method 234 can be implemented by a third-party server and stored in a database such as a database of the databases 118. The method 234 can also be implemented by the server 116 of the central facility 104. Therefore, the method 234 can generate reference signatures that are associated with one or more language identifiers (such as primary match identifier for a respective language and/or secondary match identifier for a respective language as described herein). The reference signatures can be stored in the database in association with their language identifiers. The reference signature can be selected at the block 236 from a database associated with the central facility 104 or a database associated with a third-party.

In one or more aspects, the block 238, the media content voice analysis can be software or software modules programmed in the server 116 (such as the language identifier module 136 described herein). The media content voice analysis can be software or software modules (such as the language identifier module 136 described herein) programmed in the server 116 or other hardware associated with the central facility 104. The media content voice analysis can use speech-to-text conversion, also referred to herein as, voice-to-text analysis to determine a language identifier that corresponds to a language of a media content associated with the asset. The media content voice analysis can use a collected signature from the meter or a reference signature stored in a database of the databases 118, determine using voice-to-text analysis characteristics (such as vibrations, pitch, duration, phonemes, Mel-Frequency Cepstral Coefficients, etc.) of the audio signal, analyze the characteristics of the audio signal, and determine a language identifier associated with the asset. Analyzing the characteristics of the audio signal can include matching phonemes and using pattern recognition to determine a most probable language from the voice-to-text analysis so that the language identifier can be determined and/or selected based on the most probable language. Analyzing the characteristics of the audio signal can include using machine learning, artificial intelligence, or natural language processing to determine a most probable language identifier from the voice-to-text analysis. For example, natural language processing can be used to analyze sentence structure and grammar to determine the language associated with the signature so that the language identifier can be determined and selected. Analyzing the characteristics of the audio signal can include using signature analysis to determine a most probable language and determine the language identifier based on the most probable language. The media content voice analysis determines the language of the underlying media content at a particular time. For example, a movie can be primarily in German but include a scene in the movie can be in English. Therefore, one signature for the same movie can have a language identifier of English, while the other signatures can have a language identifier of German. The block 238 can use a previously-stored language identifier as a default to determine first if the language of the media content corresponds to the previously-stored language identifier to help speed up the processing of the media content voice analysis.

In various aspects, the block 240, the language identifier output by the media content voice analysis and/or the language identifier module 136 is compared to a previously-stored language identifier. The previously-stored language identifier can be stored in the meter and sent with the asset. The previously-stored language identifier can be associated with the meter. For example, the meter is in a French household, therefore the previously-stored language identifier is set to French. The previously-stored language identifier can alternatively be stored at the central facility 104. The previously-stored language identifier can be the last language identifier identified and/or assigned by the media content voice analysis. The previously-stored language identifier, in some aspects, corresponds to a different presentation of media content. In other aspects, the previously-stored language identifier corresponds to the same presentation of media content. The previously-stored language identifier can correspond to the same presentation of media content, and yet still be a different language identifier.

In some aspects, the block 242 occurs automatically in response to determining that the language identifier is different from the previously-stored identifier. The block 242 can include storing the language identifier to replace to previously-stored language identifier. The stored language identifier can now be the default language identifier of the meter. The default language can be used in the next media content voice analysis. The default language can be stored in association with the meter.

In one or more aspects, in response to the block 244, the previous language identifier minutes are calculated. For example, a first language identifier is German at timestamp 2:00 and the next stored language identifier is English at 2:30; then the previous language identifier minutes (i.e., German) is thirty minutes.

In several aspects, the block 246 occurs automatically after the block 244. The block 246 can be omitted in some aspects when the block 244 equates to the block 246. The total can be the total number of minutes for the language identifier that was previously-stored. The total can also include the total number of all minutes of all language identifiers.

The block 248, in various aspects, determines if the asset is complete using the server 116 and/or the language identifier module 136.

The block 250 can wait a period of time of two minutes, five minutes, or the like before proceeding to the block 238.

The block 252 can calculate the current language identifier minutes and add it to the total for that current language identifier. The block 252 can also add the current language identifier total to the total of all language identifiers.

The block 254 is the end of the method 234. In one or more aspects, the method 234 ends by storing the asset with a calculated total number of minutes of each identifier and/or total number of minutes of all language identifiers. The method 234 can include between the block 252 and the block 254 passing a most viewed language identifier of all language identifiers as primary match identifier for a media exposure environment, passing a second-most viewed language identifier of all the language identifiers as Secondary match identifier for the Media exposure environment; and using primary language identifier with time slot for primary, as described in FIG. 9A.

In some aspects, the method 234 includes creating one or more language identifier meter events by adding language identifiers to the asset as described herein, by storing language identifiers in association with the asset, and/or by calculating the total number of minutes of language identifiers.

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A meter comprising:
a processor; and
a non-transitory computer-readable storage medium, having stored thereon program instructions that, upon execution by the processor, cause performance of a set of operations comprising:
receiving audio data associated with media content from a media device;
determining a language associated with the media content based on a media content voice analysis;
assigning a language identifier associated with the language; and
creating a meter event for the language identifier.

2. The meter of claim 1, the set of operations further comprising:
determining that the media device is presenting media and in an ON-state; and
transmitting, to a server, the audio data with the meter event.

3. The meter of claim 1, wherein the meter is a wearable; and wherein the set of operations further comprise determining that the meter is collecting the audio data associated with the media content.

4. The meter of claim 1, the set of operations further comprising:
determining that the meter is collecting the audio data associated with the media content.

5. The meter of claim 1, wherein the creating the meter event for the language identifier comprises tagging the audio data with metadata corresponding to the language identifier.

6. The meter of claim 1, wherein the language identifier is a first language identifier, and wherein the set of operations further comprises determining that the first language identifier is different than a second language identifier.

7. The meter of claim 6, the set of operations further comprising:
replacing the second language identifier with the first language identifier based on a determination that the first language identifier is different than the second language identifier.

8. A non-transitory computer-readable storage medium, having stored thereon program instructions that, upon execution by a processor, cause performance of a set of operations comprising:
receiving, at a meter, audio data associated with media content from a media device;
determining, at a meter, a language associated with the media content based on a media content voice analysis;
assigning a language identifier associated with the language;
creating a meter event for the language identifier; and
transmitting, to a server, the audio data with the meter event.

9. The non-transitory computer-readable storage medium of claim 8, the set of operations further comprising:
determining that the media device is presenting media and in an ON-state.

10. The non-transitory computer-readable storage medium of claim 8, wherein the meter is a wearable; and wherein the set of operations further comprise determining that the meter is collecting the audio data associated with the media content.

11. The non-transitory computer-readable storage medium of claim 8, the set of operations further comprising:
determining that the meter is collecting the audio data associated with the media content.

12. The non-transitory computer-readable storage medium of claim 8, wherein the creating the meter event for the language identifier comprises tagging the audio data with metadata corresponding to the language identifier.

13. The non-transitory computer-readable storage medium of claim 8, wherein the language identifier is a first language identifier, and wherein the set of operations further comprises determining that the first language identifier is different than a second language identifier.

14. The non-transitory computer-readable storage medium of claim 13, the set of operations further comprising:
replacing the second language identifier with the first language identifier based on a determination that the first language identifier is different than the second language identifier.

15. A method comprising:
receiving, at a meter, audio data associated with media content from a media device;
determining a language associated with the media content based on a media content voice analysis;
assigning a language identifier associated with the language; and
creating a meter event for the language identifier by tagging the audio data with metadata corresponding to the language identifier.

16. The method of claim 15, further comprising:
determining that the media device is presenting media and in an ON-state.

17. The method of claim 15, further comprising:
determining that the meter is collecting the audio data associated with the media content.

18. The method of claim 15, further comprising:
transmitting, to a server, the audio data with the meter event.

19. The method of claim 15, wherein the language identifier is a first language identifier, and wherein the method further comprises determining that the first language identifier is different than a second language identifier.

20. The method of claim 19, further comprising:
replacing the second language identifier with the first language identifier based on a determination that the first language identifier is different than the second language identifier.
